(19) United States
(12) Patent Application Publication
(10) Pub. No.: US 2006/0060645 A1
(43) Pub. Date: Mar. 23, 2006

(54) Medicine management system and reading device for medicine management system

(75) Inventors: Tsutomu Udaka, Ebina-shi (JP); Kenichi Kobayashi, Ebina-shi (JP); Ryuichiro Maeyama, Ebina-shi (JP); Tomoshi Hara, Minamiashigara-shi (JP); Kazuyuki Tsukamoto, Ashigarakami-gun (JP); Koji Morofuji, Ebina-shi (JP); Shinichi Tai, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/074,847

(22) Filed: Mar. 9, 2005

(30) Foreign Application Priority Data
Sep. 22, 2004 (JP) 2004-275974

(51) Int. Cl. G06F 17/00; G06K 5/00; G06Q 30/00

(52) U.S. Cl. 235/375; 235/385; 235/380

(57) ABSTRACT

A medicine management system comprising: a first IC tag given to any one of a patient's medicine record, a prescription, a medicine bag, or a consultation ticket; the first IC tag containing the prescription information including data corresponding to a medicine name; a second IC tag given to a holding unit holding a medicine, the second IC tag containing the medicine information including data for identifying a medicine; a reading part that reads prescription information from the second IC tag; and a determination part that determines on the basis of the read respective information whether the medicines are in agreement.

### FIELD OF THE INVENTION

The present invention relates to a technique for prescribing medicines at a hospital, passing a medicine bag to a patient, and setting a usage to a patient.

### BACKGROUND OF THE INVENTION

In a hospital, medicines are organized and managed using bar codes. More specifically, a bar code is affixed to a box containing (a) medicine(s) purchased from a particular pharmaceutical company. The same bar code which is affixed to a medicine box is given to a storage shelf in medicine storage. As such, medical personnel at a hospital or a clinic can verify a bar code using a reader and the medicine(s) taken out from a medicine box are/is placed on a storage shelf that has a corresponding bar code. At a time of taking medicine from a storage shelf, the medical personnel verify the name of the prescribed medicine against the medicine on the medicine storage shelf on the basis of an affixed bar code.

In this method, however, when placing several types of medicines simultaneously, the medicines may accidentally be placed, through human error, in incorrect storage places, because a plurality of medicine boxes are opened for a single prescription containing several medicines.

### DESCRIPTION OF THE RELATED ART

Patent document 1 discloses a medicine cabinet for sticking IC tags on each medicine container for such as ampoule or transfusion and organizing the containers through the IC tags. Necessary information including: medicine type, the date of manufacture, an expiry date, a lot number, the date when medicine is stored in a medicine container, and patient information are written on the IC tag. Each time a medicine is moved, all related information is added to the IC tag of the medicine. In patent document 1, an inventory management of information such as, “who, when; what; numbers; and for whom the medicine is moved” is managed by reading information from the IC tag.

Furthermore, patent document 2, in order to avoid medical errors such as dispensing the wrong medicine to a patient at a hospital, discloses a management system of handling medicine using an IC tag. In patent document 2, when an order for a medicine is made after issuing a prescription, a system management unit issues an order card including an order recording paper and an IC tag. A medical handling place such as a sickroom reads out medical-related information and sends the information to a server. In patent document 2, in response to determination information sent back from a server, a notification is made to an order card and a related medicine is taken to the sickroom of an unintended patient.

Patent document 1, however, relates to a technique for restocking medicines purchased from a pharmaceutical company on a storage shelf in a hospital so that the medicine is never out of stock; therefore, no description is made as to prescribing medicines for a patient. Although a prescription of a medicine to a patient is described in patent document 2, the configuration is complicated because medicine management is performed by a single server. Thus, a server is not suitable for managing medicines at small private hospitals, or clinics run by a single individual.

[Patent Document 1] Japanese Patent Application Laid-Open Publication 2003-93476

[Patent Document 2] Japanese Patent Application Laid-Open Publication 2002-269234

### SUMMARY OF THE INVENTION

The present invention has been made in view of the above drawbacks of the prior art, and provides a medicine management system in which an error in selecting and delivering medication is substantially decreased through a simpler and a more efficient configuration.

To address the stated problems, the present invention provides a medicine management system comprising: a first IC tag given to any one of a patient's medicine record, a prescription, a medicine bag, or a consulting ticket; the first IC tag containing the prescription information including data corresponding to a medicine name, a second IC tag given to a holding unit holding a medicine, the second IC tag contains the medicine information including data for identifying a medicine, a reading part for reading prescription information from the second IC tag; a determination part for determining on the basis of the read respective information whether the medicines are in agreement.

The configuration described above preferably comprises, a searching part that a storage unit that pre-stores the locations of a holding unit corresponding to a medicine, and searches the location of the holding unit on the basis of prescription information read from the first IC.

The configuration described above preferably comprises a measuring part that measures the specified medicine on the basis of the dosage of the prescription information, when the medicine names are in agreement.

Another invention provides a medicine management system comprising: an IC tag given to any one of a patient's medicine record, a prescription, a medicine bag, or a consultation card; the first IC tag contains the information including data corresponding to at least a medicine name and a dosage, a reading part that reads prescription information from the IC tag, a determination part that refers to the reference value of each medicine stored in a database connected to a network, thereby determining whether the amount of medicine read from the prescription information by the reading part is unsuitable.

Another invention provides a medicine management system comprising: an IC tag given to any one of a patient's medicine record, a prescription, a medicine bag, or a consultation ticket; the first IC tag contains the information including data corresponding to at least a medicine name and a dosage; a reading part that reads prescription information from the IC tag; a determination part that refers to the reference value of each medicine stored in a database connected to a network, thereby determining whether the amount of medicine read from the prescription information by the reading part is unsuitable.

Another invention provides a medicine management system comprising:

a first IC tag given to a medicine bag and the patient information including at least data for identifying a patient; a second IC tag given to a consultation ticket and the patient information including at least data for identifying a patient; a reading part that reads both patient information from the first IC tag and information from the second IC tag; and a determination part that determines whether each of the read patient information is in agreement.

Another invention provides a medicine management system comprising: an IC tag given to either one of a medicine bag or a prescription; the first IC tag contains the information including data corresponding to at least a usage and a dosage; a reading part that reads prescription information written on the IC tag; and a notification part that notifies usage and dosage read from prescription information.

In the configuration described above, the data corresponding to the usage and the dosage preferably indicates at least the type of medicine, the time of taking the medicine, and the dosage; and the notification part may notifies at least any one of or all among: a type of medicine, an image of the medicine, the time of taking the medicine, and the dosage.

In the configuration described above, the IC tag may preferably be a non contact IC tag.

The medicine management system uses a reading device comprising the reading part and the determination part.

The medicine management system uses a reading device comprising the reading part, the determination part, and the searching part.

The reading device used in medicine management system may preferably comprise communication part connected to management part that manages patient information, prescription information, and medicine information.

According to a medicine management system of the present invention, an IC tag containing prescription information including data corresponding to a name of a medicine, a usage, and dosage are entered in a patient's medicine record, a medicine bag, and a consultation ticket. By verifying information read from IC tags, a determination is made as to whether proper medicine and dosage are chosen, and delivered to the concerned patient. This system decreases the frequency of human error in choosing a medicine; thereby improving medical care significantly.

### BRIEF DESCRIPTION OF THE DRAWINGS

Embodiments of the present invention will be described in detail based on the following figures, wherein:

FIG. 1 is a schematic diagram showing a medicine management system according to one embodiment of the present invention.

FIG. 2 is a block diagram showing a printer having tag writer function of the present embodiment.

FIG. 3 is a block diagram showing a tag reader of the present embodiment.

FIG. 4 is a diagram showing the pre-process performed in the present embodiment.

FIG. 5 is a diagram showing a medicine verification process performed in the present embodiment.

FIG. 6 is a diagram showing a medicine detection process performed in the present embodiment.

FIG. 7 is a diagram showing a medicine compound process performed in the present embodiment.

FIG. 8 is a diagram showing a medicine bag verification process performed in the present embodiment.

FIG. 9 is a diagram showing a usage display process performed in the present embodiment.

FIG. 10 is a diagram showing a prescription-determining process performed in the present embodiment.

### DETAILED DESCRIPTION OF THE INVENTION

Referring next to the drawings, embodiments of the present invention will be explained.

### Embodiment

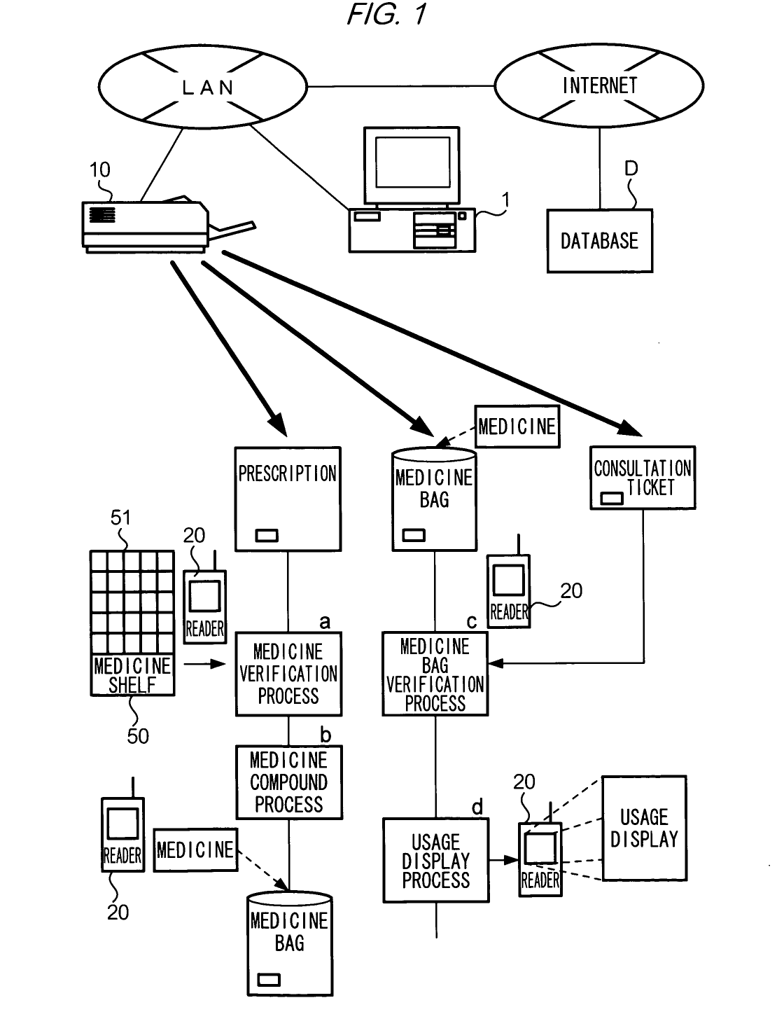

Referring to FIG. 1, a medicine management system of the present invention will be explained. The system allows compounding a medicine in a hospital by a non contact IC tag, delivery of a medicine bag to a patient, and a notification of a usage to a patient.

### Configuration

A. Overall Configuration

A terminal 1 and a printer having tag writer function 10 are connected to the LAN (Local Area Network) in a hospital; the LAN is connected to Internet via a provider (not shown). Also, database D of pharmaceutical companies are connected to Internet (FIG. 1).

It should be noted that terminal 1 is a typical personal computer equipped with a main body, a monitor, and an operating unit. The memory in the main body stores medical information and a management program by which a doctor manages patients. Specifically, personal information input in first medical examination (identification ID, name, gender, age, date of birth, allergy information etc.), prescription information input after the medical examination (identification ID, name of diagnosed disease, name of medicine prescribed, usage, dosage) are stored as medical information. A management program includes program for defining a writing operation to IC tag and a reading operation from IC tag.

B. Configuration of Printer

Printer 10 receives printing operation instruction from terminal 1 and prints patient's name or identification ID on objects such as a patient's medicine record (diagnosis recording card), a medicine bag, and a consultation ticket. Printer 10 also has a function of affixing an IC tag on a printing object, and has a function of writing information on the IC tag. Printer 10 is also able to write information on an IC tag when an IC tag is already affixed to paper.

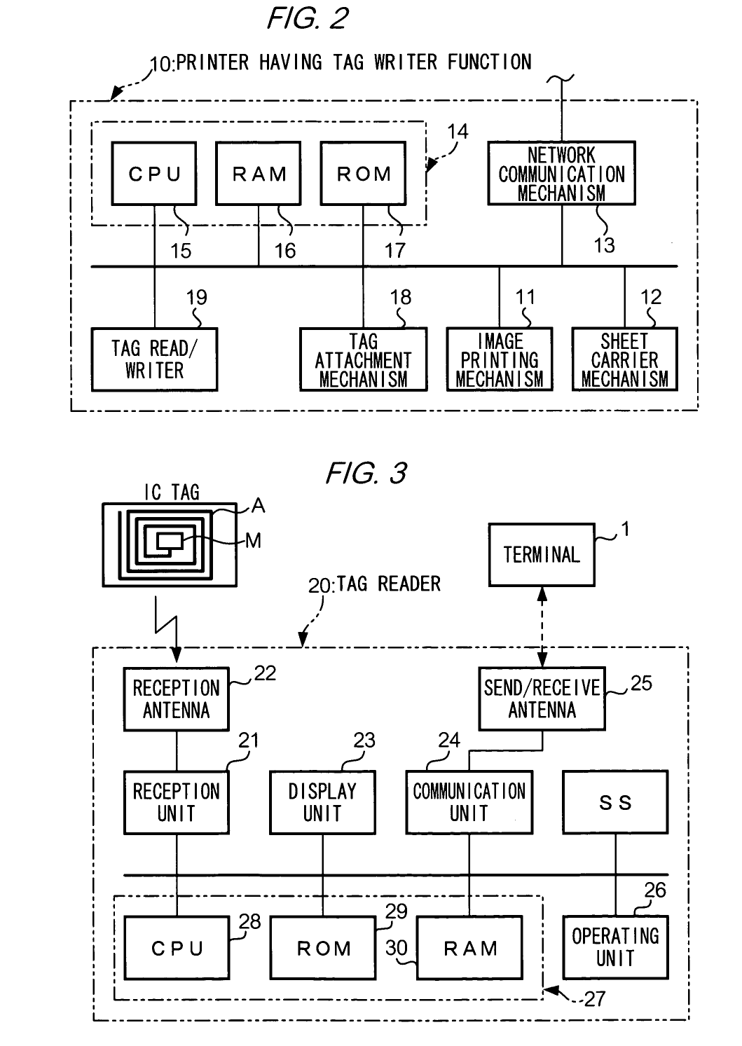

FIG. 2 is a block diagram showing the function of printer 10.

An image printing mechanism 11 is equipped with a printer engine for printing character data or image data sent from terminal 1.

A sheet carrier mechanism 12 is a mechanism for carrying a single sheet at a time and printing objects (patient's files medicine bags consultation ticket) contained in a sheet cassette, to image printing mechanism 11.

Network communication mechanism 13 is used for connecting printer 10 to LAN or public network (Internet); the mechanism has an external interface or a modem (not shown).

A control unit 14 is a microcomputer comprising a CPU (Central Processing Unit) 15, a ROM (Read Only Memory) 16, a RAM (Random Access Memory) 17. ROM 16 stores programs for performing various controls of printer 10 and programs for managing medicine, later described. CPU 11 reads out programs from ROM 16 and controls operations of each mechanism by running the programs. RAM 17 is used as a work area for CPU 11 to run a program.

A tag attachment mechanism 18 attaches an IC tag to a printing object printed an image by image printing mechanism 11. The size of a printing object is detected, and the sticking location of IC tag is changed accordingly. Glue is spread on an IC tag to make it adhere to a printing object.

The IC tag is a so-called wireless tag for exchanging data between external devices in a non-contacting state. As shown in FIG. 3, an IC tag includes nonvolatile semiconductor memory M storing the data, antenna A or a coil; the tag performs communication with external equipment through microwaves and an induction field.

A plurality of tag reader/writer 19 are set at a predetermined interval on a path for carrying printing objects. The set interval of tag reader/writer 19 is determined on the basis of the minimum length of a printing object (such as consultation ticket) used for image creation.

Tag Reader (Reader)

The tag reader used in the present embodiment will next be explained. FIG. 3 is a block diagram showing the function of tag reader 20.

Reception unit 21 allows a reception antenna 22 to perform data communication with an IC tag at a non contact state through microwaves and an induction field, and to read out data described in the IC tag.

Display unit 23 is made by a liquid panel and displays a processing result or a window for prompting to instruct a process. Communication unit 24 sends and receives signals between terminal 1 via a send/receive antenna 25. Send/receive antenna 25 and terminal 1 perform wireless communication using systems such as infrared data communication or Bluetooth.

A control unit 27 is a microcomputer comprising a CPU (Central Processing Unit) 28, a ROM (Read Only Memory) 29, a RAM (Random Access Memory) 30. ROM 29 stores programs for performing various controls of tag reader 20. CPU 28 reads out programs from ROM 29 and controls operations of each mechanism by running the programs. Operating unit 26 is a unit for operating tag reader 20 and is comprised of plural switches. The operating unit enables CPU 28 perform various operations through switching operations.

The various operations include a reading operation for reading data written on IC tags, a determination operation for comparing two items of read data, and a searching operation for searching an object on the basis of the table stored in ROM 29.

### Operation

By referring to specific examples described below, an operation of medicine management system will next be explained.

To operate the system, a compound process is performed.

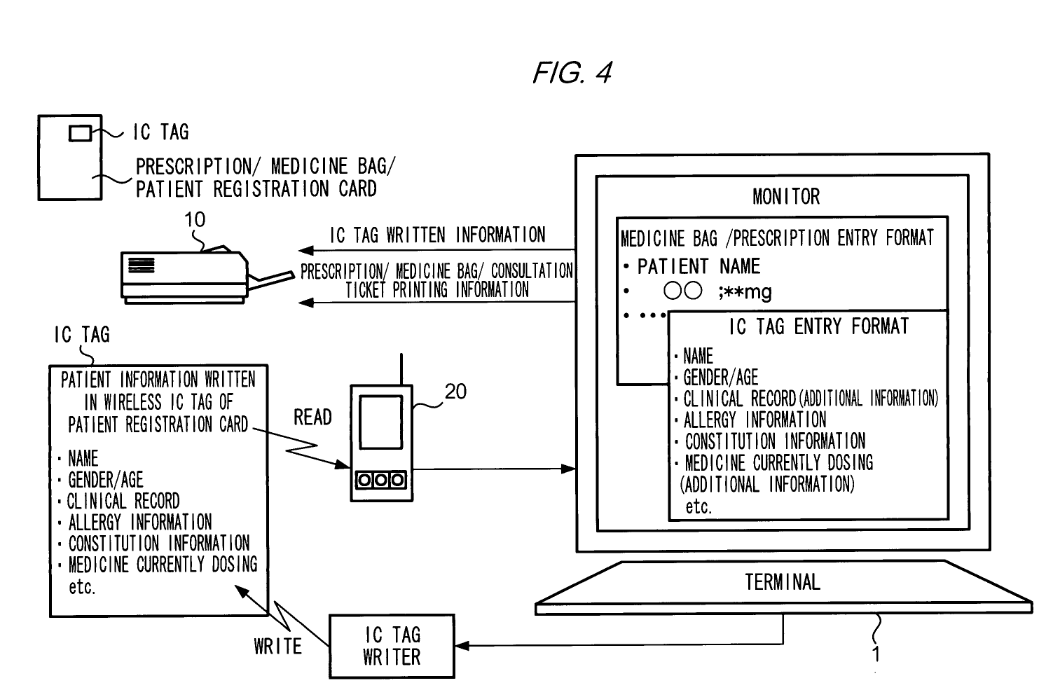

When a patient visits a hospital for a first medical examination, a doctor acquires personal information (identification ID, name, gender, age, date of birth, allergy information) of the patient. The personal information is input in terminal 1 to be stored in a storage area (FIG. 4).

Then, a consultation ticket to be passed to a patient is issued by printer 10. On the surface of a consultation ticket, a patient's name and an identification ID allocated from terminal 1 are printed; and data corresponding to personal information is written on the IC tag which is glued at the time of printing a consultation ticket.

When examining the patient, the doctor writes in a patient's medicine record and prepares a prescription of medicine. Information of the prescription is input in terminal 1 and is correlated with pre-stored personal information to be stored in a storage area. The prescription used for compounding a medicine is printed by printer 10. On the surface of the prescription, a patient's name, an identification ID and prescription contents are printed; and data corresponding to prescription information (identification ID, name of diagnosed disease, name of medicine to be given, usage, dosage) are written on the IC tag which is glued to the prescription at the time of printing.

A medicine bag to be passed to a patient is printed by printer 10. On the surface of the medicine bag, a patient's name, an identification ID and prescription contents are printed; and data corresponding to prescription information (identification ID, disease name, medicine name to be given, usage, dosage) are written on the IC tag which is glued to the medicine bag at the time of printing. FIG. 4 schematically shows a pre-process. Storage area of terminal 1 is installed with a program by which a format to briefly input personal information of a patient or a medical examination result, and a prescription is prepared. The activation of the program allows a doctor to briefly input various types of information in terminal 1. For writing information on an IC tag, an IC tag writer connected to terminal 1 is used.

Referring next to FIG. 1, the outline of a process operation according to the present system will be explained.

The process following a medical examination by a doctor is as follows.

A doctor who completes a medical examination orders a pharmaceutical chemist to compound a medicine. To compound a medicine, a pharmaceutical chemist chooses the medicine described in the prescription from a medicine shelf and performs verification of the medicine (a. medicine verification process). The pharmaceutical chemist then compounds a medicine (b. medicine compound process). Putting the compounded medicine in a medicine bag and passing the bag to a patient (c. medicine bag verification process). Instructing a patient who received the medicine bag to take the medicine by following a usage (d. usage display process).

a. Medicine Verification Process

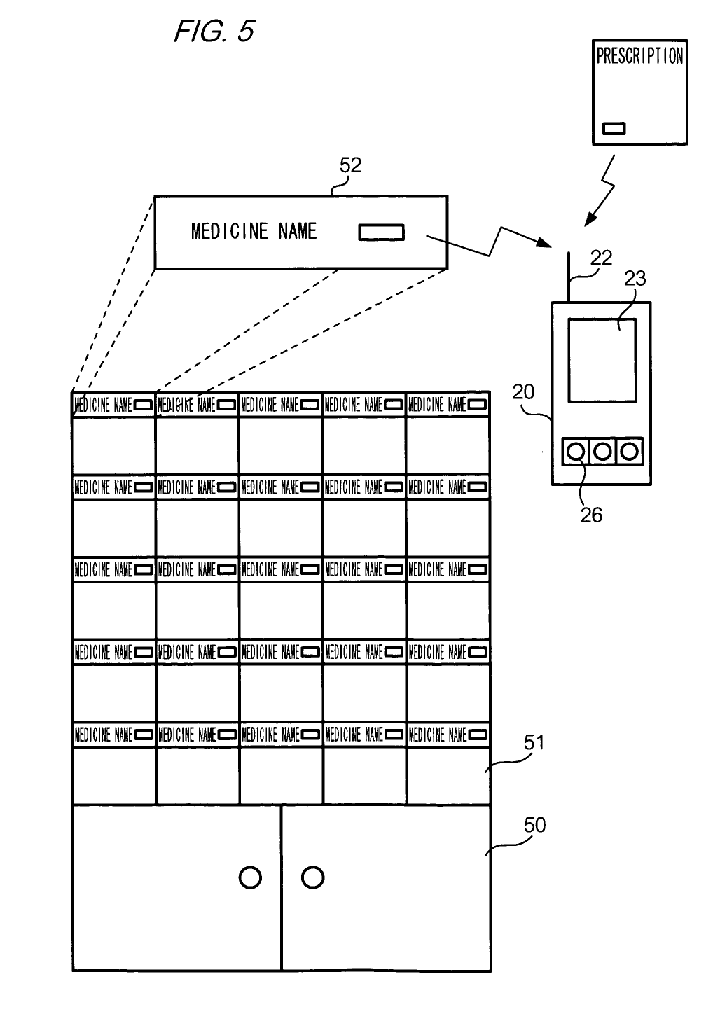

ROM 29 stores a data table correlating the location of holding storage 51 on medicine shelf 50 illustrated in FIG. 5 with the medicines stored in holding storage 51. The ROM also stores a medicine searching program for searching data holding storage 51 from the data table, in a case that a medicine is specified. Furthermore, holding storage 51 on medicine shelf 50 is affixed with a label printed with a name of a medicine and glued with an IC tag in which medicine information (a name of a medicine, a manufacturing company, a date of packing) are written.

A pharmaceutical chemist performs an operation of selecting a medicine from holding storage 51 of medicine shelf 50.

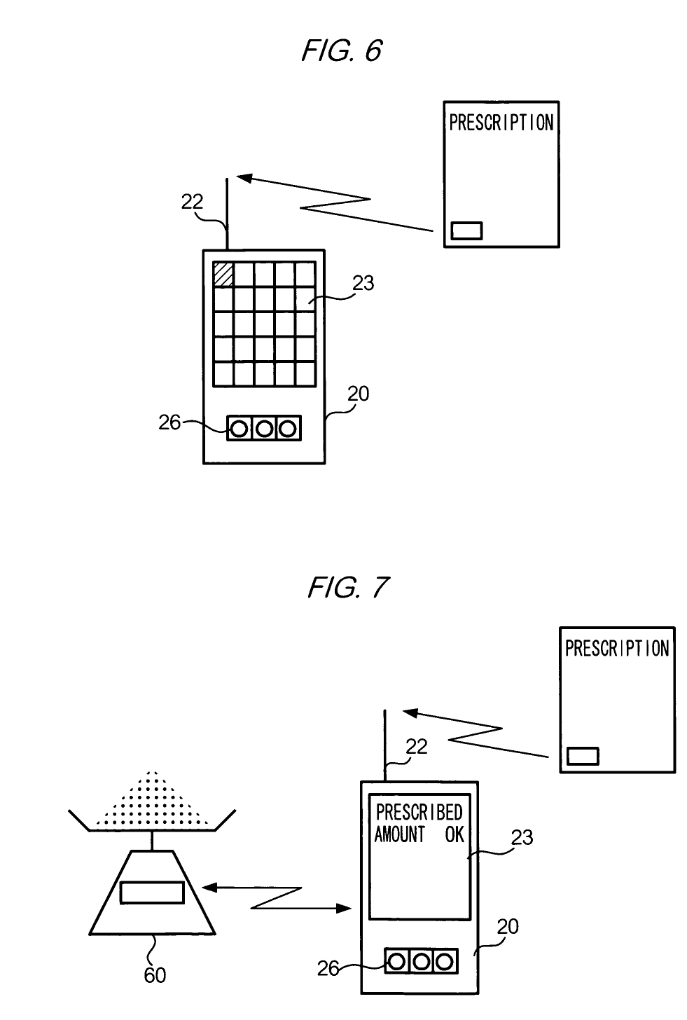

Firstly, tag reader 20 reads prescription information from an IC tag of a prescription (FIG. 5). The tag reader, on the basis of the name of the read prescription information, searches holding storage 51 of medicine shelf 50 that contains the medicine. In a case that a medicine corresponding to the read prescription information is stored in the upper left area of holding storage 51, the location of medicine shelf 50 is displayed on display unit 23 and the corresponding location lights up, as shown in FIG. 6. The lighting up function facilitates a pharmaceutical chemist to identify the location of holding storage 51 containing the specified medicine. The pharmaceutical chemist then uses tag reader 20 to read medicine information from an IC tag glued to a label of the searched holding storage 51 (FIG. 5). Tag reader 20 verifies the name of the medicine in the read prescription information with the name of the medicine in the read medicine information. The tag reader displays the agreement or disagreement of the medicine names on display unit 23. As a result of the process, an error in choosing a medicine is avoided; and accordingly, the frequency of human error made by a pharmaceutical chemist decreases.

Furthermore, by performing a searching process of holding storage 51, a pharmaceutical chemist is free from task of identifying holding storage 51, thereby improving operating efficiency (FIG. 6).

It is to be noted that a sound system SS for outputting the agreement or disagreement through a voice message may also be provided

b. Medicine Compound Process

Meter 60 shown in FIG. 7 is an electronic-type of balance which has the function of performing wireless communication in synchronization with tag reader 20. Data indicating the weights measured by meter 60 are sent to tag reader 20.

ROM 29 of tag reader 20 compares the dosage given in the prescription information with the weight sent from meter 60. When the weight reaches the dosage of a predetermined error range, the ROM displays “OK”.

First of all, a pharmaceutical chemist performs an operation for compounding (measuring) the medicine obtained in the verification process.

The pharmaceutical chemist uses tag reader 20 to read prescription information from the IC tag of a prescription (FIG. 7). In a case that prescription information is already read by tag reader 20 in the medicine verification process, the process may be omitted. The pharmaceutical chemist then connects meter 60 and tag reader 20 wirelessly and starts measuring by meter 60. When the medicine reaches the error range of the dosage, “OK” is displayed on display unit 23. The same process described above applies to a case here several types of medicine are compounded.

According to the process, an error in measuring a dose of medicine is avoided.

c. Medicine Bag Verification Process

The pharmaceutical chemist puts a compounded medicine in a medicine bag glued with a patient's name and an IC tag and then passes the bag to a patient.

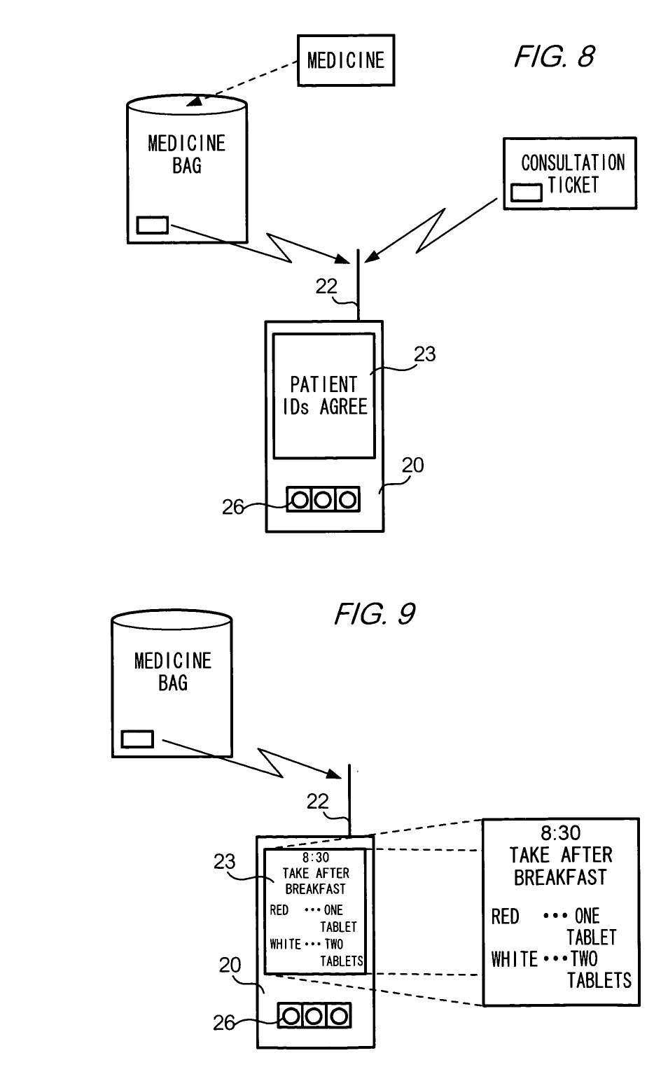

The pharmaceutical chemist uses tag reader 20 to read personal information from the IC tag of a consultation ticket owned by the patient, and also reads out prescription information from the IC tag of the medicine bag (FIG. 8). Tag reader 20 verifies the identification ID obtained from personal information with identification ID obtained from prescription information; when the IDs are in agreement, the chemist passes the medicine bag to the patient.

In summary, even in a case that patients of the same gender and name are waiting to receive medicine, the error in passing a medicine is avoided.

d. Usage Display Process

ROM 29 of tag reader 20 stores a program for displaying usage and dosage (time of taking the medicines, type, amount) according to prescription information read from the IC tag of the medicine bag.

When the patient reads prescription information from the IC tag of the medicine bag using tag reader 20 (FIG. 9), tag reader 20 displays usage and dosage on display unit 23. Specifically, the display unit displays instructions such as “Dose to be taken after breakfast. Red . . . 1 tablet, White . . . 2 tablets”. As long as a terminal is able to display image information, the terminal may also be configured to display the image information of a medicine.

The usage display process informs a patient of a dose of medicine, thereby decreasing the frequency of human errors when instructing a usage to a patient.

The reading function of tag reader 20 may also be added to a mobile phone or PDA typically used by a patient. Furthermore, a timer function may be added to tag reader 20 for sounding an alarm to prompt a patient to take the requisite dose of a medicine within the specified period of time corresponding to the lifestyle of the patient (hour of rising, mealtime, bedtime hour).

e. Prescription Determination Process

The process is a process for determining whether the medicine prescribed by a doctor is suitable.

Tag reader 20 and a medicine database D are connected. The medicine database D is managed by a pharmaceutical company and stores names of medicines and the standard given dose.

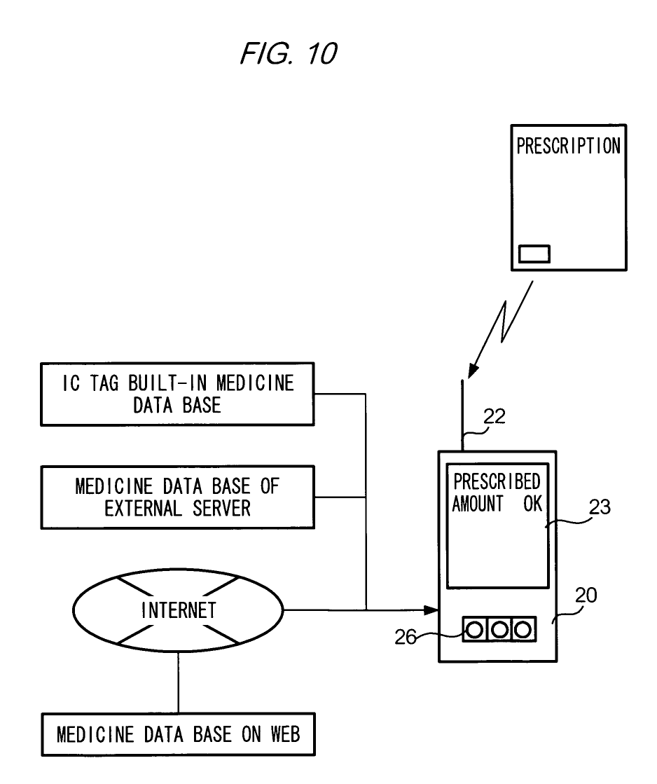

Tag reader 20 reads out prescription information from an IC tag of a prescription (FIG. 10). Tag reader 20 refers to the name of medicine in the prescription information and reads out a standard usage that corresponds to the name of the medicine in the database. The tag reader determines whether the prescription is suitable, by comparing the dosage of the prescription information with the standard dosage.

### Effect of the Embodiments

As explained, according to a medicine management system of the present embodiment, a decrease in the frequency of human error and medical error is achieved by: choosing from a medicine shelf medicine written in a prescription or a patient's medicine record and verifying the medicines for compounding the medicine (a. medicine verification process); compounding a medicine (b. medicine compound process); passing a medicine bag to a patient (c. medicine bag verification process); displaying the usage for a patient (d. usage display process). It is to be noted that the medicine management system is realizable by printer 10 having tag writer function, tag reader 20, and a simple computer system; therefore, the system is ideal for smaller hospitals or clinics run by individual practitioners.

### Modifications

In the embodiment described above, compound of medicine is performed by an IC tag attached to a prescription; however, a medicine bag may be used in place of a prescription.

Tag reader 20 and terminal 1 may arbitrarily be connected through wireless communication, so that the processing status is monitored by terminal 1.

The present invention provides a medicine management system provided with: a first IC tag given to any one of a patient's medicine record, a prescription, a medicine bag, or a patient registration card; the first IC tag containing the prescription information including data corresponding to a medicine name, a second IC tag given to a holding unit holding a medicine, the second IC tag contains the medicine information including data for identifying a medicine, a reading part for reading prescription information from the second IC tag; a determination part for determining on the basis of the read respective information whether the medicines are in agreement.

The configuration described above preferably comprises, a searching part that a storage unit that pre-stores the locations of a holding unit corresponding to a medicine, and searches the location of the holding unit on the basis of prescription information read from the first IC.

The configuration described above preferably comprises a measuring part that measures the specified medicine on the basis of the dosage of the prescription information, when the medicine names are in agreement.

Another invention provides a medicine management system provided with: an IC tag given to any one of a patient's medicine record, a prescription, a medicine bag, or a consultation ticket; the first IC tag contains the information including data corresponding to at least a medicine name and a dosage, a reading part that reads prescription information from the IC tag, a determination part that refers to the reference value of each medicine stored in a database connected to a network, thereby determining whether the amount of medicine read from the prescription information by the reading part is unsuitable.

Another invention provides a medicine management system provided with: an IC tag given to any one of a patient's medicine record, a prescription, a medicine bag, or a consultation ticket; the first IC tag contains the information including data corresponding to at least a medicine name and a dosage; a reading part that reads prescription information from the IC tag; a determination part that refers to the reference value of each medicine stored in a database connected to a network, thereby determining whether the amount of medicine read from the prescription information by the reading part is unsuitable.

Another invention provides a medicine management system provided with:

a first IC tag given to a medicine bag and the patient information including at least data for identifying a patient; a second IC tag given to a consultation ticket and the patient information including at least data for identifying a patient; a reading part that reads both patient information from the first IC tag and information from the second IC tag; and a determination part that determines whether each of the read patient information is in agreement.

Another invention provides a medicine management system provided with: an IC tag given to either one of a medicine bag or a prescription; the first IC tag contains the information including data corresponding to at least a usage and a dosage; a reading part that reads prescription information written on the IC tag; and a notification part that notifies usage and dosage read from prescription information.

In the configuration described above, the data corresponding to the usage and the dosage preferably indicates at least the type of medicine, the time of taking the medicine, and the dosage; and the notification part may notifies at least any one of or all among: a type of medicine, an image of the medicine, the time of taking the medicine, and the dosage.

In the configuration described above, the IC tag may preferably be a non contact IC tag.

The medicine management system uses a reading device provided with the reading part and the determination part.

The medicine management system uses a reading device provided with the reading part, the determination part, and the searching part.

The reading device used in medicine management system may preferably comprise communication part connected to management part that manages patient information, prescription information, and medicine information.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments, and with the various modifications as are suited to the particular use contemplated. It is intended that the scope of the invention be defined by the following claims and their equivalents.

The entire disclosure of Japanese Patent Application No. 2004-275974 filed on Sep. 22, 2004 including specification, claims, drawings and abstract is incorporated herein by reference in its entirety.

What is claimed is:

1. A medicine management system comprising:
a first IC tag given to any one of a patient's medical record, a prescription, a medicine bag, or a consultation ticket; the first IC tag containing a prescription information including a data corresponding to a medicine name;
a second IC tag given to a holding unit holding a medicine, the second IC tag contains a medicine information including a data for identifying the medicine;
a reading part for reading the prescription information from the first IC tag and reading the medicine information from the second IC tag;
a determination part for determining whether the medicines are in agreement on the basis of the information read from the first IC tag and the second IC tag.

2. A medicine management system according to claim 1 further comprising:
a storage unit that stores a relation of locations of the medicine and the holding unit;
a searching part that searches the storage unit on the basis of the prescription information read from the first IC tag to identify the location of the holding unit.

3. A medicine management system according to claim 1 further comprising:
a measuring part that measures a dosage of the medicine and outputs a measuring data indicating the measuring result;
the prescription information further comprises the dosage data that indicates the dosage of the medicine;
a measuring determination part that compares the dosage data read from the first IC tag with the measuring data output from the measuring part to determine whether the measuring data are in agreement with the dosage data.

4. A medicine management system comprising:
an IC tag given to any one of a patient's medical record, a prescription, a medicine bag, or a consultation ticket; the IC tag contains a prescription information including data corresponding to at least a medicine name and a dosage of the medicine prescribed;
a reading part that reads the prescription information from the IC tag;
a database that is connected to a network and stores a standard dosage value of each medicine;
a determination part that determines whether the dosage of the medicine read from the prescription information by the reading part is unsuitable based on the standard dosage value of each medicine stored in the database.

5. A medicine management system comprising:
a first IC tag given to a medicine bag and contains a patient information including at least a data for identifying a patient;
a second IC tag given to a consultation ticket and contains a patient information including at least a data for identifying a patient;
a reading part that reads the patient information from the first IC tag and the patient information from the second IC tag; and
a determination part that determines whether the patient information read from the first IC tag and the patient information read from the second IC tag is in agreement.

6. A medicine management system comprising:
an IC tag given to either one of a medicine bag or a consultation card; the IC tag contains a prescription information including a data corresponding to at least a usage and a dosage of a medicine;
a reading part that reads the prescription information written on the IC tag; and
a notification part that notifies the usage and the dosage of the medicine read from the prescription information.

7. A medicine management system according to claim 6, wherein:
the data corresponding to the usage and the dosage of the medicine indicates at least the type of the medicine, the time of taking the medicine, and the dosage; and
the notification part notifies at least any one of or all among: the type of the medicine, an image of the medicine, the time of taking the medicine, and the dosage.

8. A medicine management system according to claim 1, wherein the IC tag is a non-contact IC tag.

9. A medicine management system according to claim 4, wherein the IC tag is a non-contact IC tag.

10. A medicine management system according to claim 6, wherein the IC tag is a non-contact IC tag.

11. A reading device comprising a reading part and a determination part, wherein the reading device is used in a medicine management system comprising;
a first IC tag given to any one of a patient's medical record, a prescription, a medicine bag, or a consultation ticket; the first IC tag containing a prescription information including a data corresponding to a medicine name;
a second IC tag given to a holding unit holding a medicine, the second IC tag contains a medicine information including a data for identifying the medicine, and the reading part reads the prescription information from the first IC tag and the medicine information from the second IC tag, and the determination part determines whether the medicines are in agreement on the basis of the information read from the first IC tag and the second IC tag.

12. A reading device comprising a reading part and a determination part, wherein the reading device is used in a medicine management system comprising; an IC tag given to any one of a patient's medical record, a prescription, a medicine bag, or a consultation ticket; the IC tag contains a prescription information including data corresponding to at least a medicine name and a dosage of the medicine prescribed; a database that is connected to a network and stores a standard dosage value of each medicine; and the reading part reads the prescription information from the IC tag; and the determination part determines whether the dosage of the medicine read from the prescription information by the reading part is unsuitable based on the standard dosage value of each medicine stored in the database.

13. A reading device comprising a reading part and a determination part, wherein the reading device is used in a medicine management system comprising;
a first IC tag given to a medicine bag and contains a patient information including at least a data for identifying a patient;
a second IC tag given to a consultation ticket and contains a patient information including at least a data for identifying a patient;
and the reading part reads the patient information from the first IC tag and the patient information from the second IC tag;
and the determination part determines whether the patient information read from the first IC tag and the patient information read from the second IC tag is in agreement.

14. A reading device comprising a reading part, a determination part, and a searching part, wherein the reading device is used in a medicine management system comprising;
a first IC tag given to any one of a patient's medical record, a prescription, a medicine bag, or a consultation ticket; the first IC tag containing a prescription information including a data corresponding to a medicine name;
a second IC tag given to a holding unit holding a medicine, the second IC tag contains a medicine information including a data for identifying the medicine, a storage unit that stores a relation of locations of the medicine and the holding unit;
the reading part reads the prescription information from the first IC tag and the medicine information from the second IC tag,
the determination part determines whether the medicines are in agreement on the basis of the information read from the first IC tag and the second IC tag,
the searching part searches the storage unit on the basis of the prescription information read from the first IC tag to identify the location of the holding unit.

15. A reading device according to claim 11, wherein the reading device used in the medicine management system further comprising a management part and a communication part, the management part manages a patient information, the prescription information, and the medicine information, a communication part connect to the management part.

16. A reading device according to claim 12, wherein the reading device used in the medicine management system further comprising a management part and a communication part, the management part manages a patient information, the prescription information, and the medicine information, a communication part connect to the management part.

17. A reading device according to claim 13, wherein the reading device used in the medicine management system further comprising a management part and a communication part, the management part manages a patient information, the prescription information, and the medicine information, a communication part connect to the management part.

18. A reading device according to claim 14, wherein the reading device used in the medicine management system further comprising a management part and a communication part, the management part manages a patient information, the prescription information, and the medicine information, a communication part connect to the management part.
